(19) United States
(12) Patent Application Publication
(10) Pub. No.: US 2017/0310352 A1
(43) Pub. Date: Oct. 26, 2017

(54) Mobile Phone Case

(71) Applicant: Andrew Langsam, Armonk, NY (US)

(72) Inventor: Andrew Langsam, Armonk, NY (US)

(21) Appl. No.: 15/135,845

(22) Filed: Apr. 22, 2016

(51) Int. Cl. H04B 1/3888; H04M 1/02

(52) U.S. Cl. CPC H04B 1/3888; H04M 1/0202

(57) ABSTRACT

A case for a mobile phone is provided with a forefinger tip purchase or gripping area on its back so that a user can securely hold the phone and case in the palm of one hand, with pinky, ring and middle finger on the side wall of the phone with the thumb opposed for use in touching, swiping, and scrolling the touch sensitive screen of the phone, and the forefinger located behind the case, but secured thereto by the tip of the forefinger interacting with a finger tip purchase mechanism located at or near the top of the back of the case, preferably in a corner.

### BACKGROUND OF THE INVENTION

The present invention relates to a protective case for the electronics of a mobile phone. In this connection the case could be the actual container for the components of the phone, i.e., for the screen, the electronic IC's within, the batteries, the ports, etc. or, alternatively, the case is meant to also include a secondary and more protective case as the same is now sold in the after-market. Those after-market sales often are provided with designs and features which the original case for the phone do not have. The present invention is directed to a new case, whether original for the phone or an after-market case for protecting the components of the phone.

### DESCRIPTION OF THE PRIOR ART

There are original equipment manufacturer cases for mobile phones. These generally secure the electronic components of the phone from everyday damage due to use but, generally, while sturdy, do not protect the electronics and the screen from damage due to water, dropping from a high height, or other abuse. For that electronic protection (including the ICs, the screen, the batteries, the lens, memory, etc.) the original case is usually adequate but consumers, for individualization of the look of their phone and to provide even better protection, often purchase an after-market case. Those cases are plentiful, now, with the phones sliding into and being secured within the cases which are necessarily quite dimensionally individualized so that each model and manufacturer's mobile phone will be securable within a protective case. Those protective after-market cases are usually available in a variety of colors, designs, finishes, etc. mostly on the back of the phone as the front of the phone, carrying the display screen, is left “open” for easy viewing. The back of the case is generally “closed” to protect the phone and its components except for the light (for the camera function) and the lens of the camera.

These phones, when protective by the OEM case or the after-market case are generally about the size, only slightly larger, than the internal components of the phone, and in a generally rectangular shape, with rounded corners and side openings (in addition to the front for the screen) for the switches, plugs, outlets, connections, etc. The mobile phone, in an OEM case or in an after-market case is generally capable (even with today's larger monitor screens) of being held in a single hand. The other hand is then able to touch the screen (today's phones are touch screen sensitive for ease of use) and swipe, touch, displays on the screen to transmit and access various functions of the mobile phone.

Today, users are constantly accessing their phones for information and talking on the same, while the phone is held in the hand (a wire can be connected to the phone with earphones and a speaker proximal to the user's mouth). The user walks with the phone, and carries the same much of their time of moving from one location to another. While moving or standing with a phone, often the user has one of his/her hands already occupied such that a single (and usually preferred hand) is used for touching the screen, swiping, etc. so as to use the functionality of the phone. It is currently considered uncomfortable, a bit perilous (due to possibility of dropping the phone) to simultaneously hold the phone in the same hand, in the palm, while using the thumb of that hand to touch, swipe, and access the screen of the phone. When doing so, usually, three fingers of the holding hand hold the phone in the palm of the hand, across from the thumb which is used for touching and swiping on the screen, while the forefinger is placed behind the case to balance and support the phone in place. Swiping and touching with the thumb is not a secure feeling with only the forefinger holding behind the case. The user does not necessarily feel secure and there is a sense that the phone can be dropped while touching and swiping.

There seems a need for a simple, inexpensive, non-cumbersome need for a case (whether OEM or after-market) having a more secure mechanism for holding the case in the hand of the user. There seems a need for such a device which interacts with the forefinger of the user, already behind the case. A simple forefinger purchase or interaction mechanism with the tip of the forefinger would provide that security to the user such that the phone is more securely held in the palm and, yet, the other fingers grip the side wall of the phone and the thumb is fully available to touch, scroll and swipe the touch-sensitive screen of the phone.

### SUMMARY OF THE INVENTION

The present invention is directed to a mobile phone case, whether supplied as an original case by a phone manufacturer, or as an after-market protective case, which is provided with a simple forefinger tip purchase or gripping area, in the upper area (as defined by the top of the phone, i.e., usually where the camera lens is located and opposite the end of the phone usually with the touch-sensitive on-off screen button). Preferably, the forefinger tip purchase or gripping area can be in the top corner of the phone, for a right handed person near to the rear and right part of the case (when the case is flipped onto its back to view) or, for a left handed person, on the upper back and proximal the left corner of the case (again, when the case is viewed from its back). With a forefinger tip purchase or gripping area in the top (or even middle of the phone) on the back of the case, a user can easily slide his forefinger tip to the purchase (a simple loop would be adequate, a depression in the case with a covering extending above the plane of the case, for accepting the tip of the finger, too) and in this way, the other three fingers would hold onto the side wall of the phone, with the thumb available for touching, scrolling and swiping the touch sensitive screen. The phone would be securely held in place in the palm of the hand, by the interaction of the three fingers, the palm, and the forefinger behind the case and held by the purchase or gripping area, and by the thumb.

### DESCRIPTION OF THE DRAWINGS

FIG. 1 is a perspective view of a mobile phone held in a protective case provided with the present invention;

FIG. 2 is a rear perspective view of the case shown in FIG. 1, with a forefinger tip purchase or gripping area in the top right area of the case (for best use by a right-handed person);

FIG. 3 is an enlarged and partial, yet detailed view of the substitution of a forefinger tip depression with a cover extending beyond the plane of the surface of the back of the case, an alternative embodiment of the invention;

FIG. 4 is an enlarged and partial yet detailed view of the forefinger tip purchase and grippable area of the invention shown in FIG. 2 where the mechanism is located in the top and left corner of the back of the case, suitable for use by a left-handed person or at least one accessing and using his/her phone with the left hand; and

FIG. 5 is an enlarged and partial yet detailed view of another embodiment of the present invention wherein a single forefinger tip purchase and gripping area is located at the top and center of the back of the case so that a single case can be sold to users and they can hold the same by using either a right or a left hand by having their left or right forefinger tip secured beneath the forefinger tip purchase mechanism.

### DETAILED DESCRIPTION OF THE FIGURES, THE PREFERRED EMBODIMENTS AND THE INVENTION

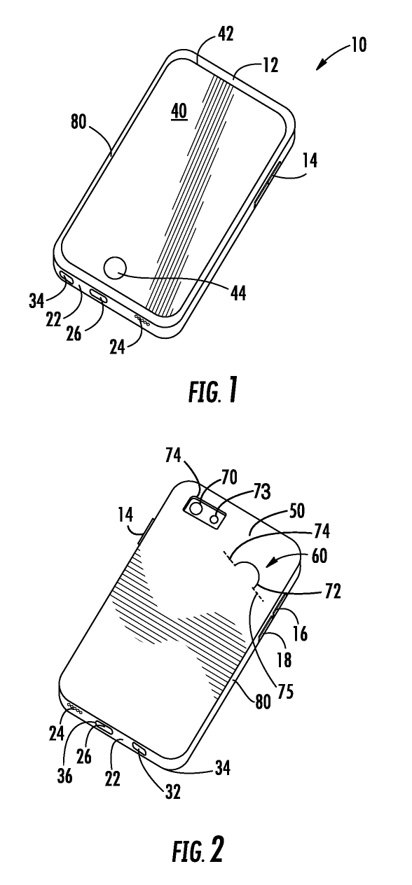

As best seen in FIG. 1, a mobile phone 10 comprises a case 12 for many internal electronic components (e.g., battery, Integrated Circuits, memory, drivers, wiring, switches, and a forwardly presenting and large touch-screen monitor. The device shown in FIG. 1 has a right hand side on-off switch 14, a pair of volume switches (16 to increase the volume and 18 to decrease the same) on the left side (when viewed from the front but when seen from the rear of the case, the volume control buttons are on the right side; see FIG. 2), and a set of holes 24 on the bottom edge 22 for the sound of an internal microphone and/or a speaker (not shown as within the case) to emanate or allow sound to pass into or out of the case. A battery connecting female plug 26 is usually located behind the aperture 30 in the middle of the bottom edge 22 of the case 10 and a female receptacle 32 for headphones, present too, just behind the opening 34 in the case 10, also at the bottom edge 22.

The touch-screen 40 comprises the front face of the phone and generally extends for most of the entire front of the case, just inside the inside top edge 42 of the case. Usually, a depression 44 in the front of the phone, near the bottom edge 22 but on the front of the touch screen 40 is provided for various functions of the mobile phone, usually to turn the screen on and to be double-clicked to change screens or functions. The depression 44 and the touch screen 40 are touch sensitive to a finger of the user to allow the user to access and use various functions of the phone—change applications, tap in words/letters/numbers and symbols, to swipe to erase or delete, to pinch to enlarge or decrease images, etc. These are well known to today's users of smartphones which are equipped with the proper electronics and touch sensitive display screens.

According to the present invention, the rear 50 of the case 12 is provided with a forefinger tip purchase or gripping area 60. The rear 50 of the case 12 of the phone 10 shown in FIG. 2 has a conventionally provided camera lens 70, an LED 72 (powered by the electronics of the phone, as desired, as a flashlight, ambient light and/or as a light synchronized with the shutter of the camera and the lens function of the smartphone), and the camera lens 70 and LED 72 are aligned with an aperture 74 also passing through the case 12 of the phone 10.

According to the embodiment of the invention shown in FIG. 2, the forefinger tip purchase area or gripping surface 60 is comprised of a simple elastic loop segment 72 which has its bights or legs 74, 75 molded into or otherwise adhered, epoxied, or secured to the rear of the case 12. The bights could actually pass through small holes in the case and into the interior compartment defined between the case and the phone or into the electronic compartment of the phone. In the embodiment shown in FIG. 2, the legs 74 and 75 are shown in dotted lines as they are secured within the small thickness of the back of the case 12, i.e., between the front surface of the back of the case 12, the surface in contact with the rear of the phone 10 if the case is an after-market case or within the compartment defined by the interior of the case if the case is an OEM case. The elastic loop segment 72 allows the forefinger tip of a user to pass thereunder and to thereby provide a fingertip purchase area for the forefinger of the user. In the embodiment shown in FIG. 2, the loop is sloped from the top of the case towards the side as the forefinger of the user will be similarly sloped or biased when the phone and case are held in the palm of the hand of the user, with the thumb accessing and interplaying with the touch sensitive screen. Of course, the elastic loop can simple extend straight across, i.e., parallel to the top of the case but it is believed to be more comfortable if the elastic loop 72 is sloped or biased as shown and described. The embodiment shown in FIG. 2 is expected to be comfortable for use by a right handed person as when the phone 10 is in the palm of that person's right hand, the forefinger tip of the right hand will easily slide beneath the elastic loop 72 and be held there by the elasticity of the same, with the balance of the forefinger balancing and holding the phone 10, between the other three fingers (pinky, ring and middle) holding the edge 80 of the case 12. The thumb and the palm, and the forefinger tip, along with the other three fingers hold the phone 10 in the palm of the hand and thereby allow ease of use of the thumb for interacting with the touch screen 40 of the phone 10. When the user is finished using the phone, removal of the same from the palm and the forefinger tip is quite easy as the forefinger tip can quite easily slide out of the elastic loop. The elasticity of the loop is adequate to allow the forefinger tip to easily, one handedly, slide into the loop, to commence use of the phone, hold the forefinger tip within the loop while in use, and, yet, is not so tight that removal is difficult.

FIG. 4 shows the elastic loop on the back 50 of the case 12 of the phone 10, but located in the corner near to the aperture 74 for the camera lens 70 and the LED 2. This elastic loop is intended to be easily slid on and off, but to maintain the “grip” between the forefinger tip of the user's left forefinger to the rear of the case of the phone, preferably for use by a user who is left handed, i.e., who desires to use the left thumb for interacting with the touch screen display. It is shown as upwardly biased or slanted from the side edge of the case towards the center line of the case just as the elastic loop 72 shown in FIG. 2 is upwardly biased or slanted from the side edge 80 towards the center line of the case 12. As mentioned, the loop can extend straight across such that it presents a loop substantially parallel with the top edge of the case.

FIG. 5 shows another embodiment of the invention with a larger loop 90, extending across the central axis A-A′. This loop 90 is expected to allow for forefinger tip purchase or gripping by either the right or left hand. It, too, has a pair of bights which are secured to the case. The forefinger tip of the hand into which the phone 10 is to be held is easily able to slide under the loop 90 and, yet, the elasticity of the loop is expected to hold the case securely in the palm of the hand, even while the user interacts with the touch screen display 40 by the thumb of that hand.

As can be seen in this embodiment, the bights of the elastic loop are parallel to the top edge of the case but, of course, even here, there can be a slight bias or slope of the loop, possibly favoring the likely more frequent use of the phone by a right handed person.

The elastic loop shown and described herein can be replaced by a simple fabric loop secured to the back of the case, similar to a toe loop in a pair of sandals. The loop of fabric can lay flat when not in use but can easily be accessed by the user sliding the tip of his/her forefinger thereunder to secure the case within the palm of the hand.

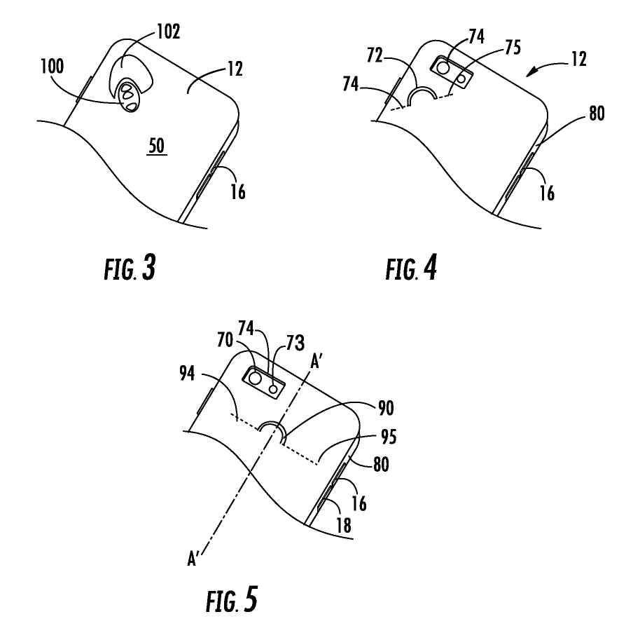

Another embodiment of the invention is shown in FIG. 3. Here, the rear 50 of the case 12 is molded with a small forefinger tip depression 100. This depression 100 is a slight concavity in the surface of the plastic of the case 12 and extends downwardly only a slight distance. A roughened surface can be provided (a set of ridges extending across the concavity) to facilitate the gripping and purchase of the forefinger tip of the user's hand, when the same is slid into the depression 100. The depression is expected to extend from the rear surface 50 of the case 12 and not below the inside surface of the after-market case. In addition, to facilitate the holding of the tip of the forefinger of the user, a convex shell 102 covering for the depression 100 can be provided. The tip of the forefinger is expected to be easily slipped between the roughened surface of the depression and the bottom and inside surface of the convex shell and be held there by friction. Sliding the tip of the forefinger in and out should be easy and quick. The convex shell 102 is expected to extend above the surface of the rear 50 of the case 12 so that the top of the convex shell is not co-planar with the bulk of the rear surface 50 of the case 12. Of course, this embodiment can be placed in the upper right (as seen from the back) of the case, not as shown in the upper left corner. In addition, in this embodiment, too, the depression can be central located (but near the top edge of the case) and the convex shell covering extending across the central axis A-A′.

1. A case for protecting and surrounding the rear surface and corners of a mobile phone having a touch-sensitive screen for direct finger contact, with the screen of the mobile phone projecting through an open front of the case, said case comprising a rear surface protecting the rear surface of said mobile phone, said case corresponding to the general rectangular shape of a mobile phone and said case thus comprising a pair of opposed side walls which are longer than a pair of opposed top and bottom walls, said rear surface of said case along with said side walls and top and bottom walls holding said case to said mobile phone, the joining of said top wall and said opposed side walls of the rear surface of said case defining top corners of said case, said case further comprising a forefinger tip purchase device near at least one of the top corners of said rear surface of said case, and said purchase device extending at an angle between one of said opposed side walls and said top wall of said case, whereby said purchase device is substantially elastic, its ends recessed and substantially flush within said rear surface of said case when the purchase device is not pulled away from said case by a forefinger tip of a user.

2. (canceled)

3. (canceled)

4. (canceled)

5. (canceled)

6. A case as claimed in claim 1 wherein said forefinger tip purchase device further comprises a finger tip depression area of said case extending downwardly from the rear surface of the case for accepting and supporting the thickness of a forefinger tip of a user.

7. (canceled)

8. (canceled)

9. (canceled)

10. A case as claimed in claim 6 wherein said depression area is provided with roughening on its surface.

11. (canceled)

12. (canceled)

13. (canceled)

14. (canceled)

15. (canceled)

16. (canceled)
